(19) United States
(12) Patent Application Publication
(10) Pub. No.: US 2018/0226198 A1
(43) Pub. Date: Aug. 9, 2018

(54) CAPACITOR PACKAGE STRUCTURE AND ANTIOXIDATION ELECTRODE FOIL THEREOF

(71) Applicant: APAQ TECHNOLOGY CO., LTD., MIAOLI COUNTY (TW)

(72) Inventor: CHING-FENG LIN, HSINCHU COUNTY (TW)

(21) Appl. No.: 15/665,702

(22) Filed: Aug. 1, 2017

(30) Foreign Application Priority Data
Feb. 8, 2017 (TW) 106104116

(51) Int. Cl. H01G 9/042; H01G 9/055; H01G 9/00

(52) U.S. Cl. CPC H01G 9/042; H01G 9/055; H01G 2009/0412; H01G 2009/0018; H01G 9/0029

(57) ABSTRACT

The present disclosure provides a capacitor package structure and an antioxidation electrode foil thereof. The antioxidation electrode foil includes a base layer, a conductive film structure, and an antioxidation film structure. The base layer has a top surface and a bottom surface. The conductive film structure includes a plurality of first conductive film layers. The antioxidation film structure includes a plurality of first antioxidation film layers. The first conductive film layers and the first antioxidation film layers are alternately stacked on top of one another and disposed on the top surface of the base layer.

### FIELD OF THE INVENTION

The present disclosure relates to a package structure and an electrode foil thereof, and more particularly to a capacitor package structure and an antioxidation electrode foil thereof.

### BACKGROUND OF THE INVENTION

Various applications of capacitors include home appliances, computer motherboards and peripherals, power supplies, communication products and automobiles. The capacitors such as solid electrolytic capacitors are mainly used to provide the functions of filtering, bypassing, rectifying, coupling, blocking or transforming. Since the solid electrolytic capacitor has the advantages of small size, large electrical capacitance and good frequency characteristic, it can be used as a decoupling element in the power circuit of a central processing unit (CPU). In general, capacitor elements are stacked together to form a stacked solid electrolytic capacitor with a high electrical capacitance. In addition, the stacked solid electrolytic capacitor of the prior art includes a plurality of capacitor elements and a lead frame. Each capacitor element includes an anode part, a cathode part and an insulating part. The insulating part is insulated from the anode part and the cathode part. More specifically, the cathode parts of the capacitor elements are stacked on top of one another.

### SUMMARY OF THE INVENTION

One aspect of the present disclosure relates to a capacitor package structure and an antioxidation electrode foil thereof.

One of the embodiments of the present disclosure provides an antioxidation electrode foil, comprising a base layer, a conductive film structure, and an antioxidation film structure. The base layer has a top surface and a bottom surface. The conductive film structure includes a plurality of first conductive film layers. The antioxidation film structure includes a plurality of first antioxidation film layers. The first conductive film layers and the first antioxidation film layers are alternately stacked on top of one another and disposed on the top surface of the base layer.

Another one of the embodiments of the present disclosure provides an antioxidation electrode foil, comprising a base layer, a conductive film structure, and an antioxidation film structure. The base layer has a top surface and a bottom surface. The conductive film structure includes a plurality of first conductive film layers and a plurality of second conductive film layers. The antioxidation film structure includes a plurality of first antioxidation film layers and a plurality of second antioxidation film layers. The first conductive film layers and the first antioxidation film layers are alternately stacked on top of one another and disposed on the top surface of the base layer, and the second conductive film layers and the second antioxidation film layers are alternately stacked on top of one another and disposed on the bottom surface of the base layer.

Yet another one of the embodiments of the present disclosure provides a capacitor package structure, comprising a winding capacitor, a package casing, a first conductive pin, and a second conductive pin. The winding capacitor includes two antioxidation electrode foils and a separation paper disposed between the two antioxidation electrode foils, and the two antioxidation electrode foils respectively are a positive foil and a negative foil. The package casing is used for encapsulating the winding capacitor. The first conductive pin has a first embedded portion electrically contacting one of the two antioxidation electrode foils and encapsulated by the package casing and a first exposed portion passing through the package casing and exposed out of the package casing. The second conductive pin has a second embedded portion electrically contacting another one of the two antioxidation electrode foils and encapsulated by the package casing and a second exposed portion passing through the package casing and exposed out of the package casing. Each of the two antioxidation electrode foils includes a base layer having a top surface and a bottom surface, a conductive film structure including a plurality of first conductive film layers, and an antioxidation film structure including a plurality of first antioxidation film layers, wherein the first conductive film layers and the first antioxidation film layers are alternately stacked on top of one another and disposed on the top surface of the base layer.

More particularly, the bottommost one of the first conductive film layers is disposed on the top surface of the base layer, the bottommost one of the first antioxidation film layers is disposed on the bottommost one of the first conductive film layers, and the topmost one of the first antioxidation film layers is disposed on the topmost one of the first conductive film layers, wherein the bottommost one of the second conductive film layers is disposed on the bottom surface of the base layer, the bottommost one of the second antioxidation film layers is disposed on the bottommost one of the second conductive film layers, and the topmost one of the second antioxidation film layers is disposed on the topmost one of the second conductive film layers.

More particularly, the bottommost one of the first antioxidation film layers is disposed on the top surface of the base layer, the bottommost one of the first conductive film layers is disposed on the bottommost one of the first antioxidation film layers, and the topmost one of the first antioxidation film layers is disposed on the topmost one of the first conductive film layers, wherein the bottommost one of the second antioxidation film layers is disposed on the bottom surface of the base layer, the bottommost one of the second conductive film layers is disposed on the bottommost one of the second antioxidation film layers, and the topmost one of the second antioxidation film layers is disposed on the topmost one of the second conductive film layers.

As such, by matching the conductive film structure with the antioxidation film structure, the thickness of the antioxidation electrode foil is decreased, thus reducing cost and improving the antioxidation function of the antioxidation electrode foil.

To further understand the techniques, means and effects of the present disclosure, the following detailed descriptions and appended drawings are hereby referred to, such that, and through which, the purposes, features and aspects of the present disclosure can be thoroughly and concretely appreciated. However, the appended drawings are provided solely for reference and illustration, without any intention to limit the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a cross-sectional schematic view of the antioxidation electrode foil according to the first embodiment of the present disclosure;

FIG. 2 shows an enlarged view of the portion II of FIG. 1;

FIG. 3 shows a partial cross-sectional schematic view of the antioxidation electrode foil according to the second embodiment of the present disclosure;

FIG. 4 shows a cross-sectional schematic view of the antioxidation electrode foil according to the third embodiment of the present disclosure;

FIG. 5 shows a cross-sectional schematic view of the antioxidation electrode foil according to the fourth embodiment of the present disclosure;

FIG. 6 shows an enlarged view of the portion IV of FIG. 5;

FIG. 7 shows a partial cross-sectional schematic view of the antioxidation electrode foil according to the fifth embodiment of the present disclosure;

FIG. 8 shows a cross-sectional schematic view of the antioxidation electrode foil according to the sixth embodiment of the present disclosure;

FIG. 9 shows a perspective schematic view of two antioxidation electrode foils, two separation papers, a first conductive pin, and a second conductive pin mated with each other according to the seventh embodiment of the present disclosure; and

FIG. 10 shows a lateral schematic view of a capacitor package structure according to the seventh embodiment of the present disclosure.

### DETAILED DESCRIPTION OF THE PREFERRED EMBODIMENTS

Embodiments of a capacitor package structure and an antioxidation electrode foil thereof according to the present disclosure are described herein. Other advantages and objectives of the present disclosure can be easily understood by one skilled in the art from the disclosure. The present disclosure can be applied in different embodiments. Various modifications and variations can be made to various details in the description for different applications without departing from the scope of the present disclosure. The drawings of the present disclosure are provided only for simple illustrations, but are not drawn to scale and do not reflect the actual relative dimensions. The following embodiments are provided to describe in detail the concept of the present disclosure, and are not intended to limit the scope thereof in any way.

### First Embodiment

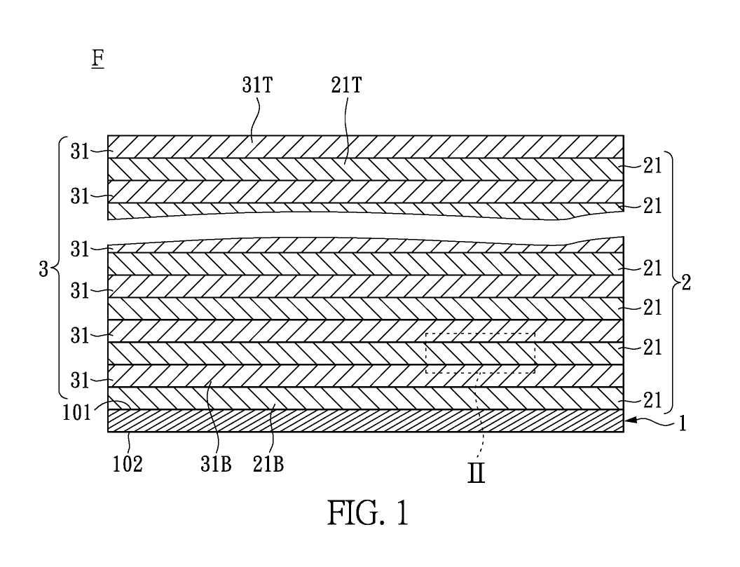

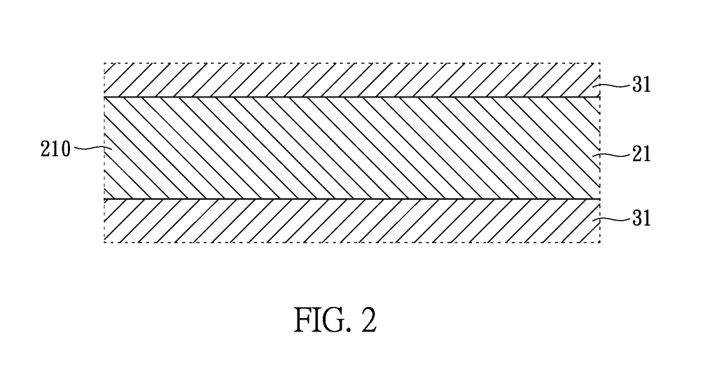

Referring to FIG. 1 and FIG. 2, the first embodiment of the present disclosure provides an antioxidation electrode foil F, including a base layer 1, a conductive film structure 2, and an antioxidation film structure 3. It should be noted that the antioxidation electrode foil F is a composite structure.

First, as shown in FIG. 1, the base layer 1 has a top surface 101 and a bottom surface 102. In addition, the conductive film structure 2 includes a plurality of first conductive film layers 21, the antioxidation film structure 3 includes a plurality of first antioxidation film layers 31, and the first conductive film layers 21 and the first antioxidation film layers 31 are alternately stacked on top of one another and disposed on the top surface 101 of the base layer 1.

More particularly, as shown in FIG. 1, the bottommost one 21B of the first conductive film layers 21 is disposed on the top surface 101 of the base layer 1, the bottommost one 31B of the first antioxidation film layers 31 is disposed on the bottommost one 21B of the first conductive film layers 21, and the topmost one 31T of the first antioxidation film layers 31 is disposed on the topmost one 21T of the first conductive film layers 21.

For example, the base layer 1 may be made of Al, Cu or other metal materials, or the base layer 1 may be made of Al alloy, Cu alloy, or other metal alloy materials. In addition, each first conductive film layer 21 may be made of Ti, Ni, Cr, Sc, V, Nb, Ta, Mo, W, Co or other metal materials, or each first conductive film layer 21 may be made of NiCr alloy or other metal alloy materials, or each first conductive film layer 21 may be made of TiNx, TiC, TiOx, Ti(O,N)x, Ti(O,C)x, Ti(C,N)x, Ti(O,N,C)x or other metal compound layers. In addition, each first antioxidation film layer 31 may be made of carbon, carbon compound, graphite, graphene, carbon nanotube, metal carbide, metal nitride carbide, metal carbide oxide, metal nitride oxide, Ag, Au, Pt, Pb, TiNx, TiC or other antioxidation materials. Moreover, as shown in FIG. 2, each first conductive film layer 21 may be a first single conductive film layer made of a first metal layer 210, and each first antioxidation film layer 31 may be a first single antioxidation film layer made of a first antioxidation layer. However, it is merely an example and is not meant to limit the scope of the present disclosure.

It should be noted that the first conductive film layers 21 of the conductive film structure 2 can be formed quickly, and the cost of forming the first conductive film layers 21 is cheaper. In addition, the thickness of each first antioxidation film layer 31 of the antioxidation film structure 3 is very thin so that each first antioxidation film layer 31 can be formed quickly. As such, by matching the conductive film structure 2 with the antioxidation film structure 3, the thickness of the antioxidation electrode foil F is decreased, thus reducing cost and improving the antioxidation function of the antioxidation electrode foil F.

### Second Embodiment

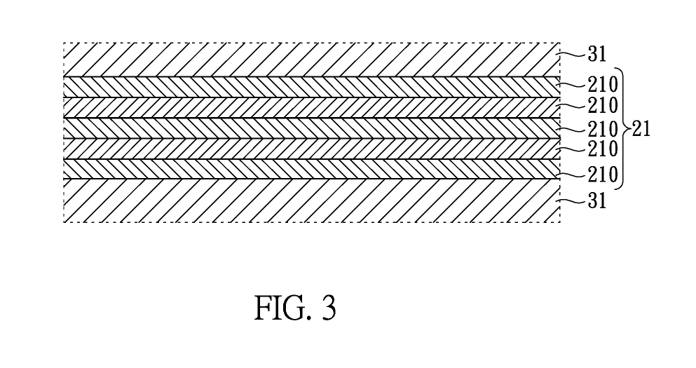

Referring to FIG. 3, the second embodiment of the present disclosure provides an antioxidation electrode foil (not shown). As compared with FIG. 3 and FIG. 2, the difference between the second embodiment and the first embodiment is as follows: in the second embodiment, each first conductive film layer 21 may be a first multilayer conductive film layer including a plurality of first metal layers 210 stacked on top of one another, and each first antioxidation film layer 31 may be a first multilayer antioxidation film layer including a plurality of first antioxidation layers stacked on top of one another. That is to say, each first conductive film layer 21 may be a first single conductive film layer made of a first metal layer 210 (as shown in the first embodiment), or each first conductive film layer 21 may be a first multilayer conductive film layer including a plurality of first metal layers 210 stacked on top of one another (as shown in the second embodiment). However, it is merely an example and is not meant to limit the scope of the present disclosure.

### Third Embodiment

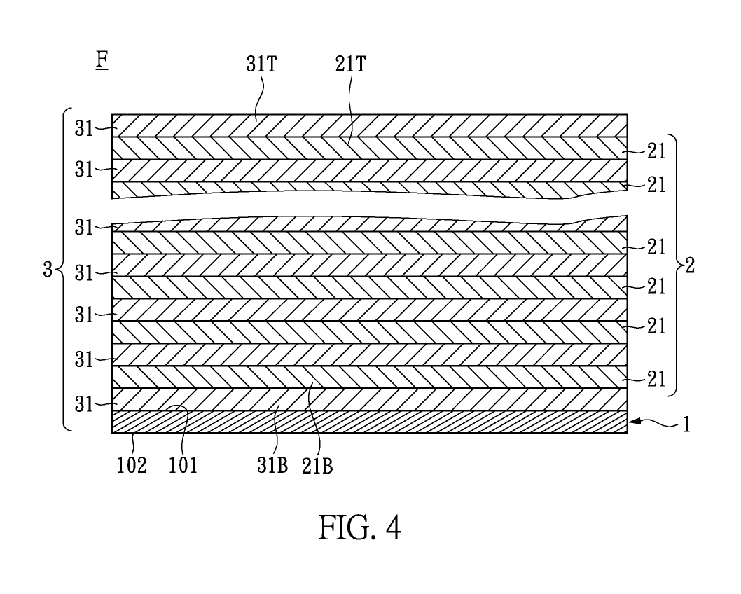

Referring to FIG. 4, the third embodiment of the present disclosure provides an antioxidation electrode foil F, including a base layer 1, a conductive film structure 2, and an antioxidation film structure 3. As compared with FIG. 4 and FIG. 1, the difference between the third embodiment and the first embodiment is as follows: in the third embodiment, the bottommost one 31B of the first antioxidation film layers 31 is disposed on the top surface 101 of the base layer 1, the bottommost one 21B of the first conductive film layers 21 is disposed on the bottommost one 31B of the first antioxidation film layers 31, and the topmost one 31T of the first antioxidation film layers 31 is disposed on the topmost one 21T of the first conductive film layers 21. That is to say, when the first conductive film layers 21 and the first antioxidation film layers 31 are alternately stacked on top of one another to form a multilayer structure, the multilayer structure has a bottommost first antioxidation film layer 31B and a topmost first antioxidation film layer 31T disposed on two opposite sides thereof.

### Fourth Embodiment

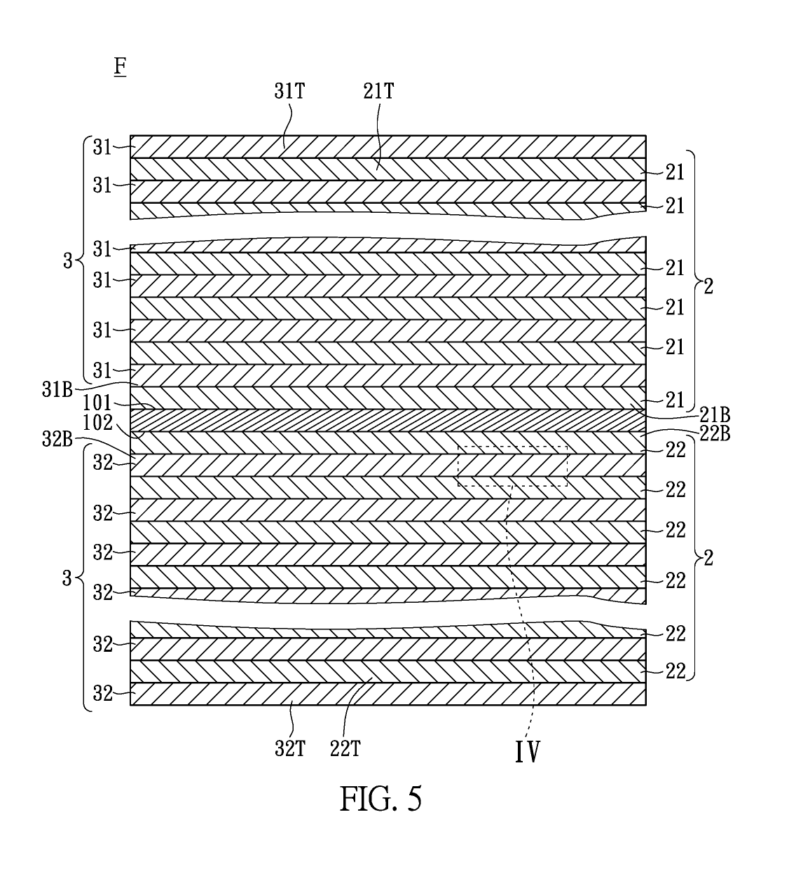

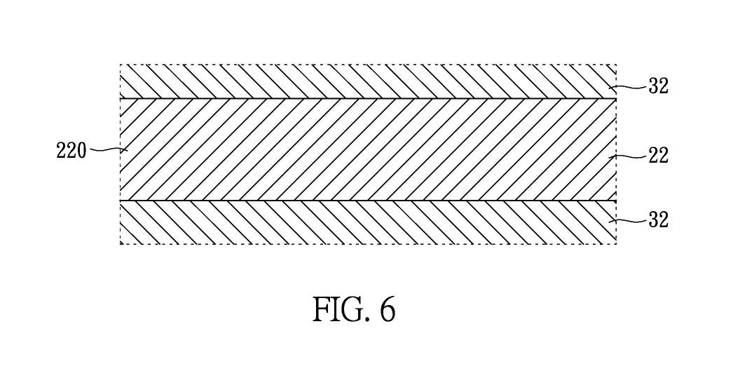

Referring to FIG. 5 and FIG. 6, the fourth embodiment of the present disclosure provides an antioxidation electrode foil F, including a base layer 1, a conductive film structure 2, and an antioxidation film structure 3. As compared with FIG. 5 and FIG. 1, the difference between the fourth embodiment and the first embodiment is as follows: in the fourth embodiment, the conductive film structure 2 further includes a plurality of second conductive film layers 22, the antioxidation film structure 3 further includes a plurality of second antioxidation film layers 32, and the second conductive film layers 22 and the second antioxidation film layers 32 are alternately stacked on top of one another and disposed on the bottom surface 102 of the base layer 1.

More particularly, as shown in FIG. 5, the bottommost one 21B of the first conductive film layers 21 is disposed on the top surface 101 of the base layer 1, the bottommost one 31B of the first antioxidation film layers 31 is disposed on the bottommost one 21B of the first conductive film layers 21, and the topmost one 31T of the first antioxidation film layers 31 is disposed on the topmost one 21T of the first conductive film layers 21. In addition, the bottommost one 22B of the second conductive film layers 22 is disposed on the bottom surface 102 of the base layer 1, the bottommost one 32B of the second antioxidation film layers 32 is disposed on the bottommost one 22B of the second conductive film layers 22, and the topmost one 32T of the second antioxidation film layers 32 is disposed on the topmost one 22T of the second conductive film layers 22.

For example, each first conductive film layer 21 may be a first single conductive film layer made of a first metal layer 210 (as shown in FIG. 2), or each first conductive film layer 21 may be a first multilayer conductive film layer including a plurality of first metal layers 210 stacked on top of one another (as shown in FIG. 3). In addition, as shown in FIG. 6, each second conductive film layer 22 may be a second single conductive film layer made of a second metal layer 220. However, it is merely an example and is not meant to limit the scope of the present disclosure.

For example, each second conductive film layer 22 may be made of Ti, Ni, Cr, Sc, V, Nb, Ta, Mo, W, Co or other metal materials, or each second conductive film layer 22 may be made of NiCr alloy or other metal alloy materials, or each second conductive film layer 22 may be made of TiNx, TiC, TiOx, Ti(O,N)x, Ti(O,C)x, Ti(C,N)x, Ti(O,N,C)x or other metal compound layers. In addition, each second antioxidation film layer 32 may be made of carbon, carbon compound, graphite, graphene, carbon nanotube, metal carbide, metal nitride carbide, metal carbide oxide, metal nitride oxide, Ag, Au, Pt, Pb, TiNx, TiC, or other antioxidation materials. However, it is merely an example and is not meant to limit the scope of the present disclosure.

It should be noted that the second conductive film layers 22 of the conductive film structure 2 can be formed quickly, and the cost of forming the second conductive film layers 22 is cheaper. In addition, the thickness of each second antioxidation film layer 32 of the antioxidation film structure 3 is very thin so that each second antioxidation film layer 32 can be formed quickly. As such, by matching the conductive film structure 2 with the antioxidation film structure 3, the thickness of the antioxidation electrode foil F is decreased, thus reducing cost and improving the antioxidation function of the antioxidation electrode foil F.

### Fifth Embodiment

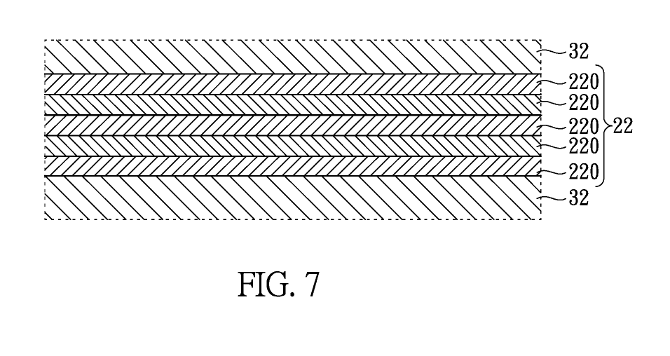

Referring to FIG. 7, the fifth embodiment of the present disclosure provides an antioxidation electrode foil (not shown). As compared with FIG. 7 and FIG. 6, the difference between the fifth embodiment and the fourth embodiment is as follows: in the fifth embodiment, each second conductive film layer 22 may be a second multilayer conductive film layer including a plurality of second metal layers 220 stacked on top of one another, and each second antioxidation film layer 32 may be a second multilayer antioxidation film layer including a plurality of second antioxidation layers stacked on top of one another. That is to say, each second conductive film layer 22 may be a second single conductive film layer made of a second metal layer 220 (as shown in the fourth embodiment), or each second conductive film layer 22 may be a second multilayer conductive film layer including a plurality of second metal layers 220 stacked on top of one another (as shown in the fifth embodiment). However, it is merely an example and is not meant to limit the scope of the present disclosure.

### Sixth Embodiment

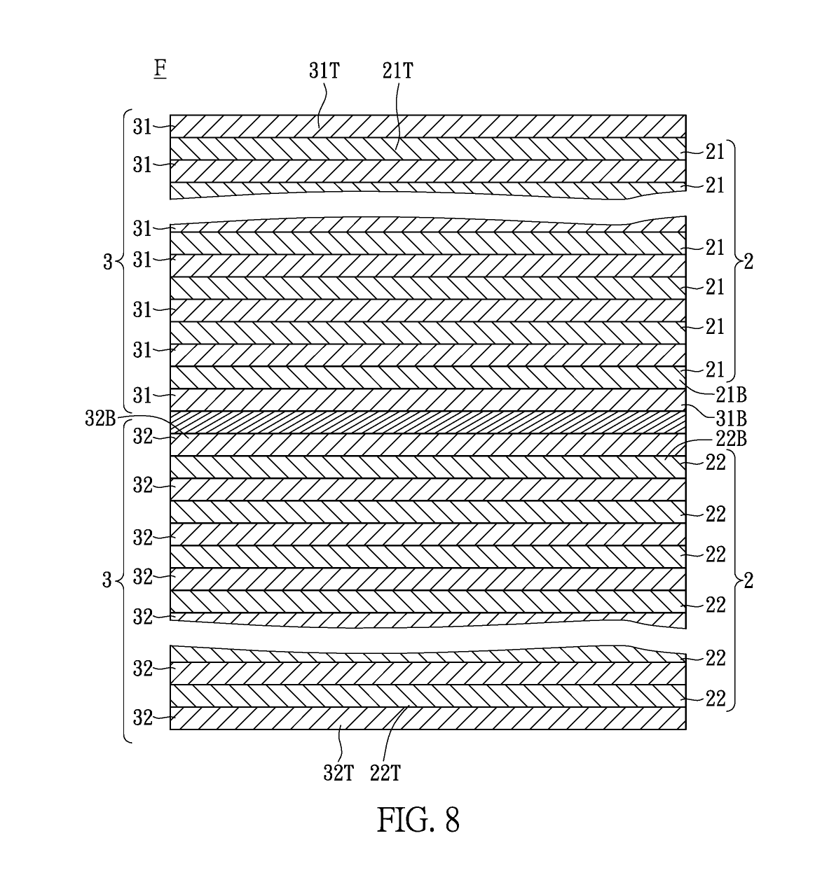

Referring to FIG. 8, the sixth embodiment of the present disclosure provides an antioxidation electrode foil F, including a base layer 1, a conductive film structure 2, and an antioxidation film structure 3. As compared with FIG. 8 and FIG. 5, the difference between the sixth embodiment and the fourth embodiment is as follows: in the sixth embodiment, the bottommost one 31B of the first antioxidation film layers 31 is disposed on the top surface 101 of the base layer 1, the bottommost one 21B of the first conductive film layers 21 is disposed on the bottommost one 31B of the first antioxidation film layers 31, and the topmost one 31T of the first antioxidation film layers 31 is disposed on the topmost one 21T of the first conductive film layers 21. That is to say, when the first conductive film layers 21 and the first antioxidation film layers 31 are alternately stacked on top of one another to form a multilayer structure, the multilayer structure has a bottommost first antioxidation film layer 31B and a topmost first antioxidation film layer 31T disposed on two opposite sides thereof.

Furthermore, the bottommost one 32B of the second antioxidation film layers 32 is disposed on the bottom surface 102 of the base layer 1, the bottommost one 22B of the second conductive film layers 22 is disposed on the bottommost one 32B of the second antioxidation film layers 32, and the topmost one 32T of the second antioxidation film layers 32 is disposed on the topmost one 22T of the second conductive film layers 22. That is to say, when the second conductive film layers 22 and the second antioxidation film layers 32 are alternately stacked on top of one another to form a multilayer structure, the multilayer structure has a bottommost second antioxidation film layer 32B and a topmost second antioxidation film layer 32T disposed on two opposite sides thereof.

In the first to the sixth embodiments, each first antioxidation film layer (31, 31B, 31T) may be a first single antioxidation film layer made of a first antioxidation layer or a first multilayer antioxidation film layer including a plurality of first antioxidation layers stacked on top of one another (the method for forming the first antioxidation layers is the same as the first conductive film layers 21 as shown in FIG. 3). In addition, in the first to the sixth embodiments, each second antioxidation film layer (32, 32B, 32T) may be a second single antioxidation film layer made of a second single antioxidation layer or a second multilayer antioxidation film layer including a plurality of second antioxidation layers stacked on top of one another (the method for forming the second antioxidation layers is the same as the second conductive film layers 22 as shown in FIG. 7).

### Seventh Embodiment

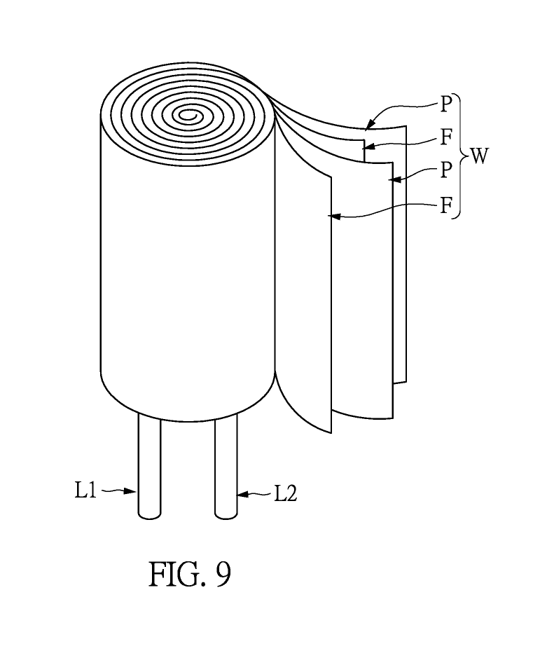

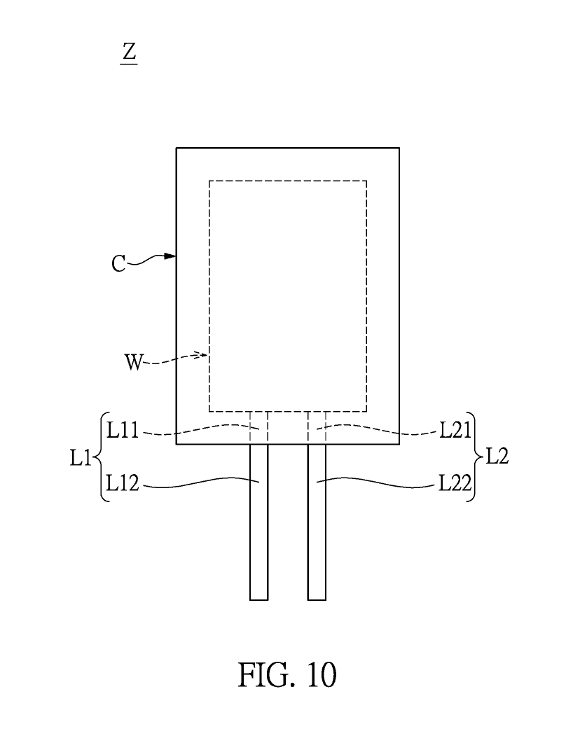

Referring to FIG. 9 and FIG. 10, the seventh embodiment of the present disclosure provides a capacitor package structure Z, including a winding capacitor W, a package casing C, a first conductive pin L1 and a second conductive pin L2. For example, the capacitor package structure Z may be a wound solid electrolytic capacitor package structure.

First, as shown in FIG. 9, the winding capacitor W includes two antioxidation electrode foils F and two separation papers P, one of the two separation papers P is disposed between the two antioxidation electrode foils F, and the two antioxidation electrode foils F respectively are a positive foil and a negative foil. Moreover, the package casing C can be used to encapsulate the winding capacitor W so as to prevent the winding capacitor W from being exposed from the package casing C. In addition, as shown in FIG. 10, the first conductive pin L1 has a first embedded portion L11 electrically contacting one of the two antioxidation electrode foils F and encapsulated by the package casing C and a first exposed portion L12 passing through the package casing C and exposed out of the package casing C. The second conductive pin L2 has a second embedded portion L21 electrically contacting another one of the two antioxidation electrode foils F and encapsulated by the package casing C and a second exposed portion L22 passing through the package casing C and exposed out of the package casing C.

For example, referring to FIG. 1, FIG. 9, and FIG. 10, each antioxidation electrode foil F includes a base layer 1, a conductive film structure 2, and an antioxidation film structure 3. The base layer 1 has a top surface 101 and a bottom surface 102. The conductive film structure 2 includes a plurality of first conductive film layers 21, the antioxidation film structure 3 includes a plurality of first antioxidation film layers 31, and the first conductive film layers 21 and the first antioxidation film layers 31 are alternately stacked on top of one another and disposed on the top surface 101 of the base layer 1. More particularly, each first conductive film layer 21 may be a first single conductive film layer made of a first metal layer 210 (as shown in FIG. 2), or each first conductive film layer 21 may be a first multilayer conductive film layer including a plurality of first metal layers 210 stacked on top of one another (as shown in FIG. 3). However, it is merely an example and is not meant to limit the scope of the present disclosure.

For example, referring to FIG. 5, FIG. 9, and FIG. 10, each antioxidation electrode foil F includes a base layer 1, a conductive film structure 2, and an antioxidation film structure 3. The base layer 1 has a top surface 101 and a bottom surface 102. The conductive film structure 2 includes a plurality of first conductive film layers 21 and a plurality of second conductive film layers 22, and the antioxidation film structure 3 includes a plurality of first antioxidation film layers 31 and a plurality of second antioxidation film layers 32. The first conductive film layers 21 and the first antioxidation film layers 31 are alternately stacked on top of one another and disposed on the top surface 101 of the base layer 1, and the second conductive film layers 22 and the second antioxidation film layers 32 are alternately stacked on top of one another and disposed on the bottom surface 102 of the base layer 1. More particularly, each first conductive film layer 21 may be a first single conductive film layer made of a first metal layer 210 (as shown in FIG. 2), or each first conductive film layer 21 may be a first multilayer conductive film layer including a plurality of first metal layers 210 stacked on top of one another (as shown in FIG. 3). Each second conductive film layer 22 may be a second single conductive film layer made of a second metal layer 220 (as shown in FIG. 6), or each second conductive film layer 22 may be a second multilayer conductive film layer including a plurality of second metal layers 220 stacked on top of one another (as shown in FIG. 7). However, it is merely an example and is not meant to limit the scope of the present disclosure.

In conclusion, the first conductive film layers 21 and the first antioxidation film layers 31 are alternately stacked on top of one another and disposed on the top surface 101 of the base layer 1, or the second conductive film layers 22 and the second antioxidation film layers 32 are alternately stacked on top of one another and disposed on the bottom surface 102 of the base layer 1, so that by matching the conductive film structure 2 with the antioxidation film structure 3, the thickness of the antioxidation electrode foil F is decreased, thus reducing cost and improving the antioxidation function of the antioxidation electrode foil F.

That is to say, the first conductive film layers 21 and the second conductive film layers 22 of the conductive film structure 2 can be formed quickly, and the cost of forming the first conductive film layers 21 and the second conductive film layers 22 is cheaper. In addition, the thickness of each first antioxidation film layer 31 and each second antioxidation film layer 32 of the antioxidation film structure 3 are very thin so that each first antioxidation film layer 31 and each second antioxidation film layer 32 can be formed quickly. As such, by matching the conductive film structure 2 with the antioxidation film structure 3, the thickness of the antioxidation electrode foil F is decreased, thus reducing cost and improving the antioxidation function of the antioxidation electrode foil F.

The aforementioned descriptions merely represent the preferred embodiments of the present disclosure, without any intention to limit the scope of the present disclosure which is fully described only within the following claims. Various equivalent changes, alterations or modifications based on the claims of the present disclosure are all, consequently, viewed as being embraced by the scope of the present disclosure.

What is claimed is:

1. An antioxidation electrode foil, comprising:
a base layer having a top surface and a bottom surface;
a conductive film structure including a plurality of first conductive film layers; and
an antioxidation film structure including a plurality of first antioxidation film layers;
wherein the first conductive film layers and the first antioxidation film layers are alternately stacked on top of one another and disposed on the top surface of the base layer.

2. The antioxidation electrode foil of claim 1, wherein the bottommost one of the first conductive film layers is disposed on the top surface of the base layer, the bottommost one of the first antioxidation film layers is disposed on the bottommost one of the first conductive film layers, and the topmost one of the first antioxidation film layers is disposed on the topmost one of the first conductive film layers.

3. The antioxidation electrode foil of claim 1, wherein the bottommost one of the first antioxidation film layers is disposed on the top surface of the base layer, the bottommost one of the first conductive film layers is disposed on the bottommost one of the first antioxidation film layers, and the topmost one of the first antioxidation film layers is disposed on the topmost one of the first conductive film layers.

4. The antioxidation electrode foil of claim 1, wherein each first conductive film layer is a first single conductive film layer made of a first metal layer or a first multilayer conductive film layer including a plurality of first metal layers stacked on top of one another, wherein each first antioxidation film layer is a first single antioxidation film layer made of a first antioxidation layer or a first multilayer antioxidation film layer including a plurality of first antioxidation layers stacked on top of one another.

5. An antioxidation electrode foil, comprising:
a base layer having a top surface and a bottom surface;
a conductive film structure including a plurality of first conductive film layers and a plurality of second conductive film layers; and
an antioxidation film structure including a plurality of first antioxidation film layers and a plurality of second antioxidation film layers;
wherein the first conductive film layers and the first antioxidation film layers are alternately stacked on top of one another and disposed on the top surface of the base layer, and the second conductive film layers and the second antioxidation film layers are alternately stacked on top of one another and disposed on the bottom surface of the base layer.

6. The antioxidation electrode foil of claim 5, wherein the bottommost one of the first conductive film layers is disposed on the top surface of the base layer, the bottommost one of the first antioxidation film layers is disposed on the bottommost one of the first conductive film layers, and the topmost one of the first antioxidation film layers is disposed on the topmost one of the first conductive film layers, wherein the bottommost one of the second conductive film layers is disposed on the bottom surface of the base layer, the bottommost one of the second antioxidation film layers is disposed on the bottommost one of the second conductive film layers, and the topmost one of the second antioxidation film layers is disposed on the topmost one of the second conductive film layers.

7. The antioxidation electrode foil of claim 5, wherein the bottommost one of the first antioxidation film layers is disposed on the top surface of the base layer, the bottommost one of the first conductive film layers is disposed on the bottommost one of the first antioxidation film layers, and the topmost one of the first antioxidation film layers is disposed on the topmost one of the first conductive film layers, wherein the bottommost one of the second antioxidation film layers is disposed on the bottom surface of the base layer, the bottommost one of the second conductive film layers is disposed on the bottommost one of the second antioxidation film layers, and the topmost one of the second antioxidation film layers is disposed on the topmost one of the second conductive film layers.

8. The antioxidation electrode foil of claim 5, wherein each first conductive film layer is a first single conductive film layer made of a first metal layer or a first multilayer conductive film layer including a plurality of first metal layers stacked on top of one another, and each second conductive film layers is a second single conductive film layer made of a second metal layer or a second multilayer conductive film layer including a plurality of second metal layers stacked on top of one another, wherein each first antioxidation film layer is a first single antioxidation film layer made of a first antioxidation layer or a first multilayer antioxidation film layer including a plurality of first antioxidation layers stacked on top of one another, and each second antioxidation film layer is a second single antioxidation film layer made of a second single antioxidation layer or a second multilayer antioxidation film layer including a plurality of second antioxidation layers stacked on top of one another.

9. A capacitor package structure, comprising:
a winding capacitor including two antioxidation electrode foils and a separation paper disposed between the two antioxidation electrode foils, wherein the two antioxidation electrode foils respectively are a positive foil and a negative foil;
a package casing for encapsulating the winding capacitor;
a first conductive pin having a first embedded portion electrically contacting one of the two antioxidation electrode foils and encapsulated by the package casing and a first exposed portion passing through the package casing and exposed out of the package casing; and
a second conductive pin having a second embedded portion electrically contacting another one of the two antioxidation electrode foils and encapsulated by the package casing and a second exposed portion passing through the package casing and exposed out of the package casing;
wherein each of the two antioxidation electrode foils includes a base layer having a top surface and a bottom surface, a conductive film structure including a plurality of first conductive film layers, and an antioxidation film structure including a plurality of first antioxidation film layers, wherein the first conductive film layers and the first antioxidation film layers are alternately stacked on top of one another and disposed on the top surface of the base layer.

10. The capacitor package structure of claim 9, wherein the conductive film structure includes a plurality of second conductive film layers, the antioxidation film structure includes a plurality of second antioxidation film layers, and the second conductive film layers and the second antioxidation film layers are alternately stacked on top of one another and disposed on the bottom surface of the base layer, wherein each first conductive film layer is a first single conductive film layer made of a first metal layer or a first multilayer conductive film layer including a plurality of first metal layers stacked on top of one another, and each second conductive film layers is a second single conductive film layer made of a second metal layer or a second multilayer conductive film layer including a plurality of second metal layers stacked on top of one another, wherein each first antioxidation film layer is a first single antioxidation film layer made of a first antioxidation layer or a first multilayer antioxidation film layer including a plurality of first antioxidation layers stacked on top of one another, and each second antioxidation film layer is a second single antioxidation film layer made of a second single antioxidation layer or a second multilayer antioxidation film layer including a plurality of second antioxidation layers stacked on top of one another.
